(19) United States
(12) Patent Application Publication
(10) Pub. No.: US 2004/0147184 A1
(43) Pub. Date: Jul. 29, 2004

(54) Flexible thermal protective compositions and coatings and structures formed with them

(76) Inventors: Edward W. Taylor Jr., Ballwin, MO (US); Robert L. Bryant, Rock Hill, MO (US); Rubin Feldman, Ladue, MO (US); Gloria Feldman, Ladue, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/469,677

(22) PCT Filed: Mar. 1, 2002
(86) PCT No.: PCT/US02/06186

(51) Int. Cl. B32B 27/04; B32B 17/04; D04H 1/00; D04H 13/00; B32B 5/12

(52) U.S. Cl. 442/20; 442/29; 428/295.1; 442/54; 442/58; 428/299.4

(57) ABSTRACT

A flexible intumescent composition for protecting a substrate against fire and thermal extremes includes an internally flexibilized epoxy binder, a carbonific, a spumific, a catalyst, and preferably additives. The compositions can be applied as coatings or can be formed into shapes, preferably sheets which are applied to or wrapped around the substrate. The sheets may be adhered to the substrate, and the ends of the wrapped sheets may be stapled or otherwise secured to each other.

### TECHNICAL FIELD

This invention relates to thermal protective compositions which form chars when exposed to fire or other thermal extremes. The invention is particularly well suited to use in epoxy resin, intumescent coatings for substrates and as novel intumescent sheets, but its usefulness is not limited thereto.

### BACKGROUND ART

Various compositions are known which provide protection against fire and other thermal extremes, such as temperatures above about 300° C. Some of the compositions are foamed inorganic passive insulative compositions which protect merely by their low thermal conductivity and their thickness as applied. These include, for example, foamed cement or intumesced silicates. The present invention is not concerned with such systems, but with systems which include a polymeric binder and which form a char when exposed to fire or hyperthermal conditions. The char-forming compositions may operate by various modalities. The compositions may be used in various forms, including thick film (mastic) coatings, thin film coatings, castings, extrusions, and others. The compositions may include organic or inorganic binders and various additives. Upon exposure to heat the compositions slowly lose weight as portions of the composition are volatilized, and a char is formed which provides a measure of protection against the transfer of heat energy. Eventually, the char is consumed by physical erosion and by chemical processes, primarily oxidation by oxygen in the air and by free radicals produced by the coating or otherwise in a fire environment, and protection is lost. The length of time required for a given temperature rise across a predetermined thickness of the composition, under specified heat flux, environmental, and temperature conditions, is a measure of the effectiveness of the composition in providing thermal protection.

When subjected to fire or other hyperthermal conditions, different coatings behave differently.

Ablative coatings swell to less than twice their original thickness. They provide limited passive thermal protection, but they tend to produce dense chars having good physical and chemical resistance.

Intumescent coatings swell to produce a char more than five times the original thickness of the coating. This char provides an insulative blanket which provides superior thermal efficiency, but at the cost of some of the physical and chemical properties of the ablative coatings. The char of the intumescent materials tends to form coarse and irregular cell structures, cracks, and fissures as it expands, and the char may not expand uniformly at corners, leaving areas where the char provides far less protection than the average thermal protection of the underlying structure. Examples of the intumescent systems include silicate solutions or ammonium phosphate paints or mastic compositions such as those disclosed in Nielsen et al., U.S. Pat. No. 2,680,077, Kaplan, U.S. Pat. No. 3,284,216, Ward et al., U.S. Pat. No. 4,529,467, or Deogon, U.S. Pat. No. 5,591,791.

A third type of char-forming coating is a subliming coating disclosed in Feldman, U.S. Pat. No. 3,849,178. When subjected to thermal extremes, these compositions both undergo an endothermic phase change and expand two to five times their original thickness to form a continuous porosity matrix. These coatings tend to be tougher than intumescent coatings. They provide far longer thermal protection than ablative coatings, frequently longer than intumescent coatings, in part because the gasses formed by the endothermic phase change provide active cooling as they work their way through the open-cell matrix. These coatings may also have a tendency to crack and form voids and fissures.

The present invention relates primarily to the Feldman-type subliming compositions which undergo an endothermic phase change and swell two to five times their original thickness. Some aspects of the invention are also applicable to intumescent char-forming coatings.

Additionally, thermal protective systems have long been formed as self-supporting shapes formed, for example, by molding or extruding a protective material similar to, or identical with, the foregoing coating materials. Such free-standing systems are described, for example, in Feldman, U.S. Pat. No. 4,493,945. Such systems suffer from the considerable expense of casting, molding, or extruding the shapes, and from the fact that the shapes and sizes of each system must be determined prior to forming the shape.

In both the coating systems and the free-standing systems, it is often useful to incorporate a mesh of some sort to strengthen the system. Examples of such mesh are metal mesh and cloth mesh such as fiberglass or graphite mesh. The mesh may be formed in many known ways, such as weaving and knitting. The term “mesh” is used broadly herein to include any perforate material.

Sometimes the materials are first applied to a reinforcing structure such as a flexible tape or flexible wire mesh, and the combined structure is applied to the substrate. Examples of this approach are found in Feldman, U.S. Pat. No. 3,022,190, Pedlow, U.S. Pat. No. 4,018,962, Peterson et al, U.S. Pat. No. 4,064,359, Castle, U.S. Pat. No. 4,276,332, and Fryer et al, U.S. Pat. No. 4,292,358. In these last-mentioned systems, the purpose of the reinforcing structure may be both to strengthen the resulting composite and to permit its application to a substrate without directly spraying, troweling or painting the uncured coating materials onto the substrate. In any of the foregoing methods and structures, multiple layers are frequently applied to the substrate to provide additional protection.

### SUMMARY OF THE INVENTION

In accordance with one aspect of the present invention, generally stated, a thermal protective composition is provided which when exposed to flame or thermal extreme exhibits a volume increase through the formation of an expanded char, the composition comprising a flexible epoxy resin, the resin being internally flexibilized with soft resin segments contributing to the overall flexibility of the resin. The composition preferably includes a component which volatilizes at fixed temperatures to absorb and block heat. Preferably, the composition responds to hyperthermal conditions with a small volume increase of two to five times its initial thickness to form an open cell matrix.

The internally flexibilized epoxy resins which are useful in the present invention are widely available. The resins have sufficient flexibility that a flat 175 mil (4.5 mm) sheet of the material can be rolled by hand around a one inch (25.4 mm) pipe at room temperature (23° C.). Internally flexibilized epoxy resins have been known for many years, as evidenced by Sellers, et al, U.S. Pat. No. 3,522,210. The internally flexibilized epoxy resin's soft resin segments are preferably alkylene or oxyalkylene units. Representative of such resins are a butyl glycidyl ether-modified bisphenol A diglycidyl ether epoxy resin having an epoxy equivalent of about 310 to about 390 sold by Ciba Geigy Ltd. as XB-4122 or PY-4122US. Several similar commercial flexible epoxies are described in Fretz, U.S. Pat. No. 4,793,703 and Kitabatake et al, U.S. Pat. No. 4,883,830, which gives a generalized formula (I) for a preferred group of epoxy compounds suitable for use in the present invention.

The preferred compositions of the invention comprise a part A including the internally flexibilized epoxy resin and a part B including a polysulfide, most preferably a polymer of bis-(ethylene oxy)methane containing disulfide linkages and curable terminal thiol groups. The two part system of the preferred compositions includes a curing agent. An amine curing agent is preferred. The preferred compositions also include gas formers such as polyol spumifics, amine blowing agents, and phosphate acid producers.

In the presently preferred embodiments, the composition includes from about 20% to about 65% polysulfide-modified flexible epoxy resin, more preferably about 40% to about 60% polysulfide-modified flexible epoxy resin.

In the preferred embodiments, the composition is in the form of a sheet of material about two to about thirty millimeters thick, more preferably about 3-15 mm thick, most preferably about 3-10 mm thick.

Other additives may be included in the composition for their known properties. Merely by way of example, boron or zinc may be included in the composition or incorporated in a surface layer. Fillers may be included for their known properties. Some or all of the additives of Deogon, U.S. Pat. No. 5,591,791, Feldman et al., U.S. Pat. No. 5,372,846, Feldman et al., U.S. Pat. No. 5,622,774, and Deogan et al., U.S. Pat. No. 5,591,791 may be incorporated in the present compositions.

Although not presently preferred, it is also possible to include in the coatings and structures of the present invention both a lower layer in accordance with the invention and an upper layer of an ablative fire protective material. The ablative material may be of a different composition, but it is preferred that the ablative material includes an internally flexibilized epoxy resin. The upper layer, in these embodiments, forms an open cell matrix when exposed to a jet fire to permit passage of gasses from the lower layer to ambient.

The compositions of the present invention have outstanding adhesive qualities. They are therefore well adapted to direct application to a substrate by standard methods such as spraying, troweling, or rolling.

In accordance with preferred embodiments of the invention, they can also be formed into sheets by applying them to a surface having a mold release agent applied to it. Because the cured compositions of the present invention, unlike conventional epoxy resins, can be wrapped around a small pipe, having a diameter of 1″ (25.4 mm) or less, the sheets can be wrapped around almost any substrate, particularly structural substrates. The sheets can therefore be easily adapted to protecting structures of almost any size or shape. They can be used with standoffs, or they can be adhered to the substrate with a contact cement, or preferably with a thin layer of the uncured composition itself. When wrapped around a substrate, the sheet is preferably adhered to the substrate and the ends of the sheet are held to each other by overlapping and securing with a mechanical fastener as by stapling.

The flexible properties of the sheets also make the sheets useable by themselves as free standing structural elements. They can, for example, be bent into substantially rectangular cross sections and used without little or no underlying structure as cable trays.

The ability of the sheets of the present invention to bend around relatively sharp corners greatly reduces the labor required to install fire-protective sheets around columns, beams, cable trays, and other structural elements. When ordinary fire protective sheets or boards are bent around corners, they must be scored before they are bent, and the scored edges filled with additional material. The sheets of the present invention do not require scoring to be bent around corners and thus eliminate the need to fill the edges.

The coatings and structures of the present invention may include a mesh reinforcing layer, preferably embedded in the composition. Fiberglass and graphite fabrics are presently favored as the mesh, although flexible ceramic fabrics, metal mesh and other types of mesh may also be used.

The coatings and structures of the present invention have been found to provide excellent protection against fire or other thermal extreme. A flexible sheet having a thickness of 0.175″ (4.5 mm) wrapped around a 1.5″ (38.1 mm) solid rod provides over 51 minutes of protection against a 900° C. standard fire (maximum temperature rise to 400° C. in a furnace rising to 500° C. in five minutes, 700° C. in ten minutes, 800° C. in twenty minutes, and 900° in forty-six minutes).

The foregoing patents are all incorporated herein by reference.

### BRIEF DESCRIPTION OF THE DRAWINGS

FIG. 1 is a graph showing average furnace temperature and average sample temperature of a 1.5″ (38.1 mm) diameter solid metal rod protected by a 0.175″ (4.5 mm) sheet of the present invention, wrapped around the rod.

### BEST MODE FOR CARRYING OUT THE INVENTION

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention.

### EXAMPLE 1

A composition of the present invention was prepared containing a two-component epoxy. The composition is formulated to be thermally activated by flame or thermal extreme; it volatilizes at fixed temperatures, exhibiting a small volume increase through the formation of an open cell matrix, and absorbs and blocks heat to protect the substrate material. The composition included a polyfunctional alcohol, a 1,3,5-triazine-2,4,6-triamine, an internally flexibilized epoxy resin and a polymer of bis-(ethylene oxy)methane containing disulfide linkages and curable terminal thiol groups (a polysulfide). The composition had a nominal formula as follows:

Weight percent

| | |
|---|---|
| Melamine | 5 |
| Ammonium polyphosphate | 25 |
| Pentaerythritol | 10 |
| Flexible epoxy resin | 30 |
| Polysulfide | 20 |
| Glass fibers | 5 |
| Catalyst | 5 |

The composition was spread on a plate (previously coated with a standard release agent) to a nominal thickness of 0.175″ (4.5 mm). A graphite fabric was pressed into the layer of material before it set. The layer was allowed to cure at 30° C. for one month.

### EXAMPLE 2

A test article was prepared by coating a solid 1.5″ (38.1 mm) diameter metal rod with a contact adhesive. The sheet of EXAMPLE 1 was wrapped around the rod, and the excess was cut off, leaving a small overlap. The overlap was stapled to the underlying sheet, and the stapled area was filled with uncured composition of EXAMPLE 1. The test article was cured for about sixteen hours.

### EXAMPLE 3

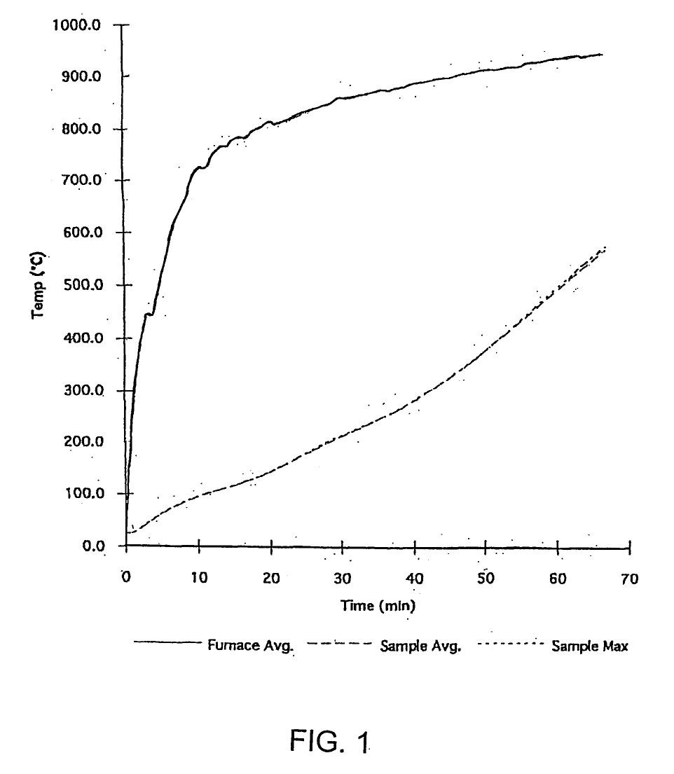

The test article prepared in accordance with EXAMPLE 2 was exposed to a simulated fire in accordance with the conditions of ASTM E-119. The actual conditions are shown in FIG. 1. The test showed that the system provided approximately fifty-one minutes of protection under the conditions of the test.

In view of the above, it will be seen that the several objects and advantages of the present invention have been achieved and other advantageous results have been obtained.

As various changes could be made in the above constructions without departing from the scope of the invention, it is intended that all matter contained in the above description or shown in the accompanying drawings shall be interpreted as illustrative and not in a limiting sense.

1. A thermal protective composition which when exposed to flame or thermal extreme exhibits a volume increase through the formation of an expanded char, the composition comprising a flexible epoxy resin, the resin being internally flexibilized with soft resin segments contributing to the overall flexibility of the resin.

2. The composition of claim 1 wherein the soft resin segments are alkylene or oxyalkylene units.

3. The composition of claim 1 wherein the flexible epoxy resin is an alkyl glycidyl ether-modified bisphenol A diglycidyl ether epoxy resin.

4. The composition of claim 1 wherein the flexible epoxy resin has an epoxy equivalent of about 310 to about 390.

5. The composition of claim 1 wherein the composition includes a component which volatilizes at fixed temperatures to absorb and block heat.

6. The composition of claim 1 wherein the composition responds to hyperthermal conditions with a small volume increase of two to five times its initial thickness to form an open cell matrix.

7. The composition of claim 1 wherein the compostion further comprises a polysulfide.

8. The composition of claim 7 wherein the composition is formed in part from a polymer of bis-(ethylene oxy)methane containing disulfide linkages and curable terminal thiol groups.

9. The composition of claim 7 further comprising an amine curing agent.

10. The composition of claim 1 further comprising a polyol spumific, an amine blowing agent, and a phosphate acid producer.

11. The composition of claim 1 wherein the composition comprises from about 20% to about 65% polysulfide-modified flexible epoxy resin.

12. The composition of claim 11 wherein the composition comprises about 40% to about 60% polysulfide-modified flexible epoxy resin.

13. An article comprising a sheet of the composition of claim 1, the sheet being about two to about thirty millimeters thick.

14. The article of claim 13 wherein the article is bent into a substantially rectangular cross-section.

15. The article of claim 13 wherein the sheet is adhered to a substrate.

16. The article of claim 13 wherein the sheet is self-supporting.

17. The article of claim 13 wherein the sheet is about three to about fifteen millimeters thick.

18. The article of claim 17 wherein the sheet is about three to about ten millimeters thick.

19. The article of claim 13 having embedded therein a mesh.

20. The article of claim 19 wherein the mesh is a fabric formed of fiberglass or graphite.

21. A substrate protected by a layer of the composition of claim 1.

22. The substrate of claim 14 wherein the composition is adhered to the substrate.

23. A method of protecting a substrate from fire or hyperthermal conditions comprising applying to the substrate a layer about two to about thirty millimeters thick of a composition which when exposed to flame or thermal extreme exhibits a volume increase through the formation of an expanded char, the composition comprising a flexible epoxy resin, the layer being sufficiently flexible that a flat 4.5 mm sheet of the material can be rolled by hand around a 25.4 mm pipe at room temperature.
